(19) United States
(12) Patent Application Publication
(10) Pub. No.: US 2005/0156822 A1
(43) Pub. Date: Jul. 21, 2005

(54) Panel driving apparatus

(75) Inventors: Jin-Sung Kim, Cheonan-si (KR); Woo-Joon Chung, Asan-si (KR); Kyoung-Ho Kang, Suwon-si (KR); Seung-Hun Chae, Suwon-si (KR); Tae-Seong Kim, Asan-si (KR)

Correspondence Address: MCGUIREWOODS, LLP, 1750 TYSONS BLVD, SUITE 1800, MCLEAN, VA, 22102, US

(73) Assignee: Samsung SDI Co., Ltd.

(21) Appl. No.: 10/964,927

(22) Filed: Oct. 15, 2004

(30) Foreign Application Priority Data
Oct. 17, 2003 (KR) 10-2003-0072509

(51) Int. Cl. G09G 3/28

(52) U.S. Cl. 345/60

(57) ABSTRACT

A panel driving apparatus for driving a panel having a plurality of panel blocks for a sustain discharge is provided. The panel driving apparatus includes a sustain discharge circuit part supplying a sustain pulse through an output terminal to the panel, and a switching part having a plurality of control switches for connecting the output terminal of the sustain discharge circuit part to the plurality of panel blocks. When electrodes of the panel are separated in blocks, the panel driving apparatus can be implemented at a low cost without any circuit variation during sustain discharge.

### CROSS REFERENCE TO RELATED APPLICATIONS

This application claims priority to Korean Patent Application No. 2003-72509, filed on Oct. 17, 2003, in the Korean Intellectual Property Office, the disclosure of which is herein incorporated in its entirety by reference.

### BACKGROUND OF THE INVENTION

1. Field of the Invention

The present invention relates to a panel driving apparatus for displaying an image by applying a sustain pulse to an electrode structure, which forms a display cell of a plasma display panel.

2. Description of the Related Art

FIG. 1 is a view illustrating a structure of a conventional 3-electrode surface discharge plasma display panel (PDP). As shown, a conventional surface discharge PDP 1 includes a front glass substrate 100, a rear glass substrate 106, address electrode lines A₁ to Aₘ, dielectric layers 102 and 110, Y electrode lines Y₁ to Yₙ, X electrode lines X₁ to Xₙ, a phosphor layer 112, barrier ribs 114, and a MgO layer 104 as a protective layer.

The address electrode lines A₁ to Aₘ are formed on a front side of the rear glass substrate 106 in a predetermined pattern. A lower dielectric layer 110 is deposited on the front sides of the address electrode lines A₁ to Aₘ. The barrier ribs 114 are formed on a front side of the lower dielectric layer 110 in a direction parallel to the address electrode lines A₁ to Aₘ. The barrier ribs 113 partition discharge regions of display cells and prevent cross-talk between the display cells. The phosphor layer 112 is formed between the barrier ribs 114.

The X electrode lines X₁ to Xₙ and the Y electrode lines Y₁ to Yₙ are perpendicular to one another and formed on a rear surface of the front glass substrate 100 in a predetermined pattern. Each intersection defines a corresponding display cell. The X electrode lines X₁ to Xₙ and the Y electrode lines Y₁ to Yₙ can be formed by coupling transparent electrode lines Xₙₐ and Yₙₐ, which are formed of transparent conductive material such as indium tin oxide (ITO), with metal electrode lines X_{nb} and X_{nb}, which increase conductivity. The front dielectric layer 102 can be formed by performing an entire deposition on rear surface of the X electrode lines X₁ to Xₙ and the Y electrode lines Y₁ to Yₙ. The protective layer 104, for example MgO layer, protects the panel 1 from an electric field and can be formed by performing an entire deposition on rear surface of the front dielectric layer 102. The discharge space 108 is sealed with a plasma forming gas.

A method for driving such a conventional PDP will now be described. A reset step, an address step, and a sustain step are sequentially performed in unit subfield. In the reset step, the charge states of the display cells to be driven become uniform. In the address step, the charge states of the selected display cells and the charge states of the non-selected display cells are determined. In the sustain step, the display discharge is performed in the selected display cells. At this time, the plasma is formed from the plasma forming gas sealed within the display cells that perform the display discharge. The phosphor layers 112 of the display cells are excited by ultraviolet radiation and thus light is emitted.

FIG. 2 is a view illustrating a conventional driving apparatus of the PDP shown in FIG. 1.

Referring to FIG. 2, a conventional driving apparatus of the PDP includes an image processor 300, a logic controller 302, an address driver 306, an X-driver 308, and a Y-driver 304. The image processor 300 converts an external analog image signal into a digital signal to generate an internal image signal consisting of, for example, 8-bit red (R), green (G) and blue (B) image data, a clock signal, vertical and horizontal synchronization signals. The logic controller 302 generates driving control signals S_{A}, S_{Y} and S_{X} depending on the internal image signals from the image processor 300. The address driver 306 processes the address signal S_{A} to generate a display data signal and applies the display data signal to the address electrode lines. The X-driver 308 processes the X driving control signal S_{X} and applies the processed signal to the X electrode lines. The Y-driver 304 processes the Y driving control signal S_{Y} and applied the processed signal to the Y electrode lines.

An example of address-display separation of a conventional flat display device is disclosed in U.S. Pat. No. 5,541,618. FIG. 3 illustrates an address-display separation (ADS) driving method with respect to Y electrode lines of the PDP shown in FIG. 1. As shown, a unit frame can be divided into eight subfields SF1 to SF8 in order to realize the time-division gray scale and each subfield SF1 to SF8 has a reset period (not shown), an address period A1 to A8, and a sustain period S1 to S8.

During each address period A1 to A8, the display data signals are applied to the address electrode lines A₁ to Aₘ. Simultaneously, the corresponding scan pulses are applied to the Y electrode lines Y₁ to Yₙ in sequence.

During each sustain period S1 to S8, the sustain pulses are alternately applied to the Y electrode lines Y₁ to Yₙ and the X electrode lines X₁ to Xₙ. During each address period A₁ to A₈, the display charge happens in the discharge cells having wall charges.

Luminance of the PDP is proportional to the number of the sustain discharge pulses within the sustain period S1 to S8 of unit frame. When one frame forming one image is represented with eight subfields and 256 grades, the respective subfields can be allocated with different sustain pulses in a ratio of 1, 2, 4, 8, 32, 64 and 128 in sequence. For example, a 133-grade luminance can be achieved by addressing the cells and performing the sustain discharge during the first, third and eighth subfield periods.

The number of the sustain discharges allocated to each subfield can be determined variably depending on weight values of the subfields, based on an automatic power control (APC). Also, the number of the sustain discharges allocated to each subfield can be changed variously considering a gamma characteristic or panel characteristic. For example, the gray scale level allocated to the fourth subfield can decrease from 8 to 6 and the gray scale level allocated to the sixth subfield can increase from 32 to 34. Also, the number of the subfields forming one frame can be changed variously depending on the design specification.

FIG. 4 is a timing diagram illustrating the driving signals of the PDP of FIG. 1. In detail, FIG. 4 illustrates the driving signals applied to the address electrodes A, the common electrode X, and the scan electrodes Y₁ to Yₙ within one subfield SF in an address display separated (ADS) driving method of a conventional AC PDP. Referring to FIG. 4, one subfield SF has a reset period PR, an address period PA, and a sustain period PS.

During the reset period PR, a write discharge is performed by applying a reset pulse to the scan lines of all groups, thereby initializing the state of the wall charges of all cells. The reset period PR is performed all over the entire screen prior to the address period PA, making the wall charges arranged in a uniform and desired distribution. The cells initialized during the reset period PR are formed with similar wall charge conditions inside the cells. After the reset period PR, the address period PA is performed. During the address period PA, the bias voltage Ve is applied to the common electrode X, and the scan electrodes Y₁ to Yₙ and the display cells are selected by simultaneously turning on the address electrodes A₁ to Aₘ at the cell positions to be displayed. After the address period PA, the sustain period PS is performed to alternately apply the sustain pulses Vs to the common electrode X and the scan electrodes Y₁ to Yₙ. During the sustain period PS, a voltage VG of low level is applied to the address electrodes A₁ to Aₘ.

### SUMMARY OF THE INVENTION

The present invention provides a panel driving apparatus for driving a panel having electrodes separated in blocks, in which the panel driving apparatus can be provided at a low cost without circuit variation during a sustain discharge.

According to an aspect of the present invention, there is provided a panel driving apparatus for use in a panel having a plurality of panel blocks for a sustain discharge. The panel is driving apparatus includes: a sustain discharge circuit part for applying a sustain pulse through an output terminal to the panel; and a switching part having a plurality of control switches for connecting the output terminal of the sustain discharge circuit part to the plurality of panel blocks.

Each of the control switches may include two FET switches serially connected in an opposite direction. In one embodiment, when one control switch is turned on, the remaining control switches are turned off, such that the remaining panel blocks are in an idle period while the sustain pulse is applied to one panel block.

Each of the control switches may include one FET switch, and each FET may have a drain connected to the output terminal of the sustain discharge circuit part, and a source connected to the corresponding panel block. When one control switch is turned on, the remaining control switches are turned off, and a voltage equal to or lower than a low level of the sustain pulse is applied to the turned-off panel blocks.

In an embodiment where each of the control switches includes one FET switch, each FET may have a source connected to the output terminal of the sustain discharge circuit part, and a drain connected to the corresponding panel block. When one control switch is turned on, the remaining control switches are turned off so that a voltage equal to or higher than a high level of the sustain pulse is applied to the turned-off panel blocks.

### BRIEF DESCRIPTION OF THE DRAWINGS

The above and other features and advantages of the present invention will become more apparent by describing in detail exemplary embodiments thereof with reference to the attached drawings.

FIG. 1 is a view illustrating a structure of a 3-electrode surface discharge PDP.

FIG. 2 is a view illustrating a conventional driving apparatus of the PDP shown in FIG. 1.

FIG. 3 illustrates an address-display separation (ADS) driving method with respect to Y electrode lines of the conventional PDP shown in FIG. 1.

FIG. 4 is a timing diagram illustrating the driving signals of the PDP of FIG. 1.

FIG. 5A illustrates an embodiment when a sustain discharge is driven in a PDP having n blocks according to an embodiment of the present invention.

FIG. 5B is a block diagram of a panel driving apparatus according to an embodiment of the present invention.

FIG. 6 is a detailed view of the panel driving apparatus shown in FIG. 5B according to an embodiment of the present invention.

FIG. 7 is a view illustrating a modification of the panel driving apparatus shown in FIG. 6.

FIG. 8 is a detailed view of the panel driving apparatus shown in FIG. 5 according to another embodiment of the present invention.

FIG. 9 is a view illustrating a modification of the panel driving apparatus shown in FIG. 8.

FIG. 10 is a diagram of a driving waveform of the panel driving apparatus shown in FIG. 8.

FIG. 11 is a diagram of a driving waveform of the panel driving apparatus shown in FIG. 9.

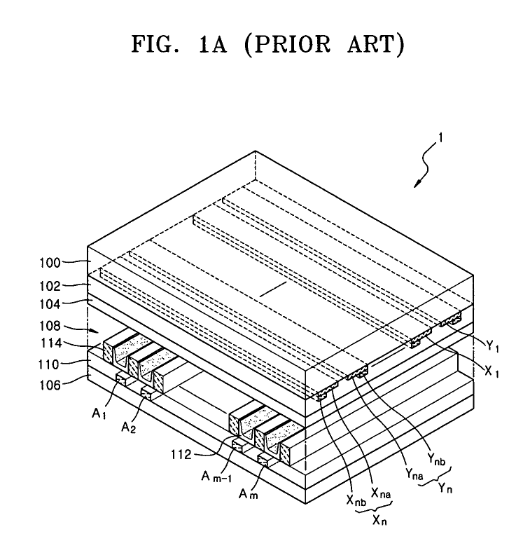

### DETAILED DESCRIPTION OF THE INVENTION

The present invention will now be described more fully with reference to the accompanying drawings, in which exemplary embodiments of the invention are shown.

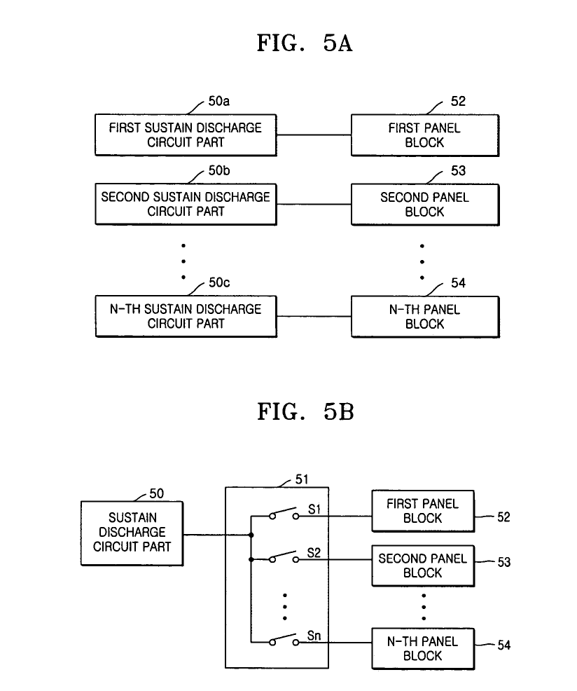

FIG. 5A illustrates an embodiment when a sustain discharge is driven in a PDP having n blocks. Referring to FIG. 5A, a first to n-th panel blocks 52 to 54 are driven by a first to n-th sustain discharge circuit parts 50a to 50c, respectively. Each of the sustain discharge circuit parts may include switching elements, analog elements, diodes, capacitors, etc. In theory, each of the sustain discharge circuit parts has an equal configuration. However, in practice, each of the sustain discharge circuit parts has a different characteristic due to a circuit variation, and thus a variation may occur between the panel blocks driven by the sustain discharge circuit parts.

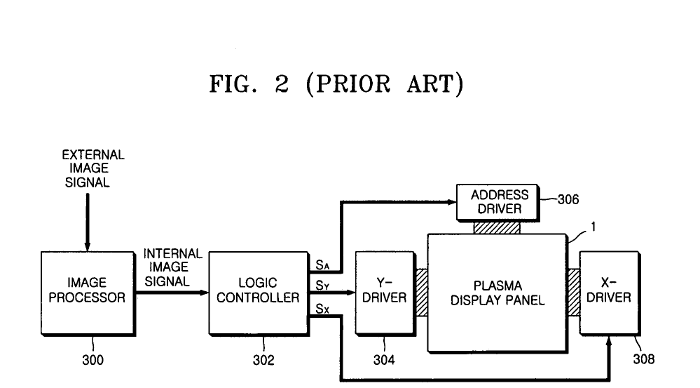

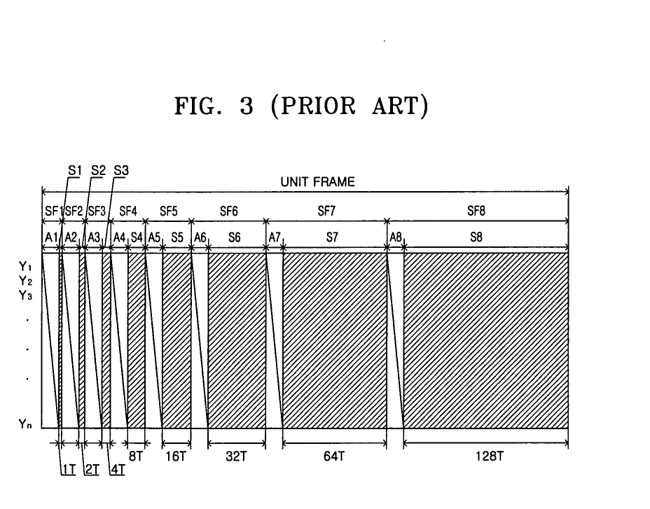

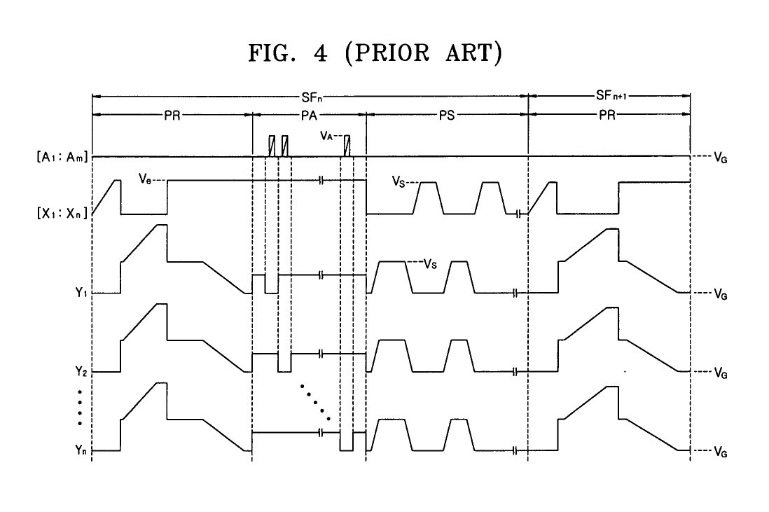

FIG. 5B is a block diagram of a panel driving apparatus according to an embodiment of the present invention. As illustrated, a sustain discharge circuit part 50 generates a sustain pulse to panel blocks. The sustain discharge circuit 50 can receive the control signals S_{X} and S_{Y} from the logic controller 302 of FIG. 2 and can be provided within the X-driver 308 and the Y-driver 304.

A switching part 51 having n switches S₁ to Sₙ connects the sustain discharge circuit part 50 with the first to n-th panel blocks 52 to 54 sequentially or simultaneously.

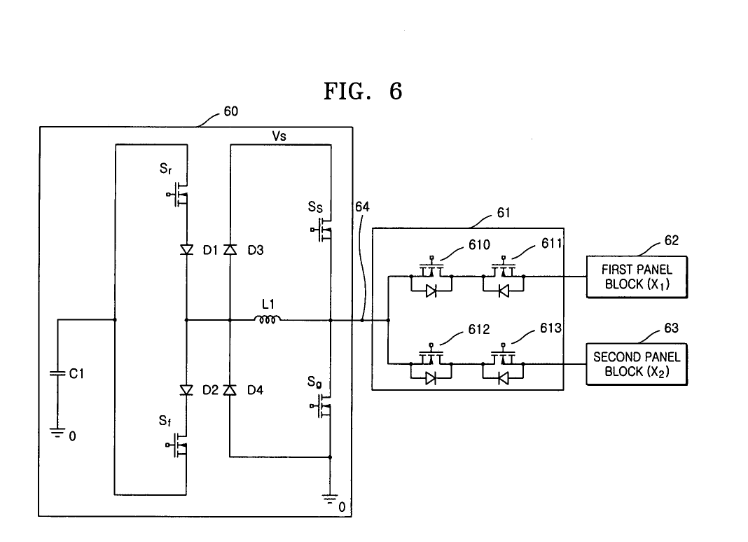

FIG. 6 is a detailed view of the panel driving apparatus shown in FIG. 5B according to an embodiment of the present invention. In FIG. 6, the panel driving apparatus includes two panel blocks 62 and 63. As shown, one sustain discharge circuit part 60 is connected to the first and second panel blocks 62 and 63 by a switching part 61. The sustain discharge circuit part 60 includes a power switch Sₛ and a ground switch S_{g} and generates a sustain pulse. If necessary, the sustain discharge circuit part 60 may include a charge collecting capacitor C1, a rising switch Sᵣ, a falling switch S_{f}, diodes D1 and D2, and a resonance coil L1, and performs an energy recovery operation.

The switching part 61 includes a first switching unit for switching the sustain discharge circuit part 60 and the first panel block 62, and a second switching unit for switching the sustain discharge circuit part 60 and the second panel block 63. The first switching unit includes two FET switches 610 and 611 connected in an opposite direction. Referring to FIG. 6, the first FET 610 has a source connected to an output terminal 64 of the sustain discharge circuit part 60, and a drain connected to a drain of the second FET 611. The second FET 611 has a source connected to the first panel block 62. Accordingly, diodes connected to the FETs 610 and 611 have opposite directions to each other. When the two FETs of the first switching unit are simultaneously turned on/off, the sustain discharge circuit part 60 and the first panel block 62 are completely connected or disconnected. The second switching unit (612, 613) has the same structure as the first switching unit.

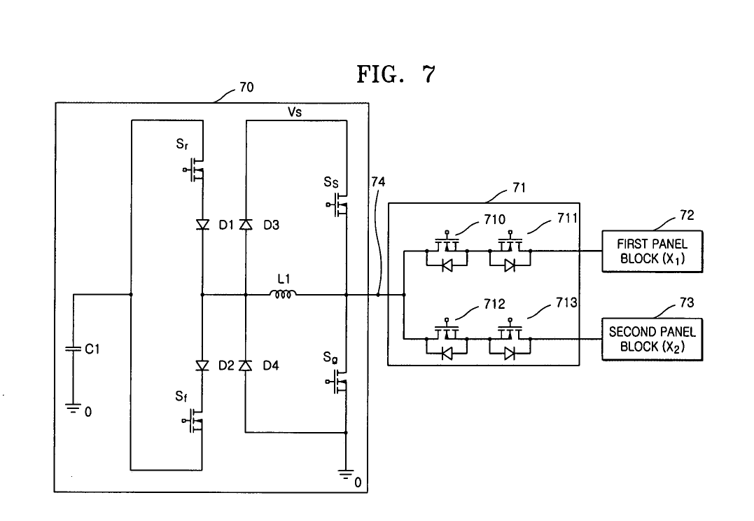

FIG. 7 is a view illustrating a modification of the panel driving apparatus shown in FIG. 6. A difference is that FETs of a switching part 71 has an opposite direction to those of FIG. 6.

One sustain discharge circuit part 70 is connected to first and second panel blocks 72 and 73 by a switching part 71. A structure and operation of the sustain discharge circuit part 70 shown in FIG. 7 is equal to those of the sustain discharge circuit part 60 shown in FIG. 6.

The switching part 71 includes a first switching unit for switching the sustain discharge circuit part 70 and the first panel block 72, and a second switching unit for switching the sustain discharge circuit part 70 and the second panel block 73. The first switching unit includes two FET switches 710 and 711 connected in an opposite direction. Referring to FIG. 7, the first FET 710 has a drain connected to an output terminal 74 of the sustain discharge circuit part 70, and a source connected to a source of the second FET 711. The second FET 711 has a drain connected to the first panel block 72. Accordingly, diodes connected to the FETs 710 and 711 have opposite directions to each other. When the two FETs of the first switching unit are simultaneously turned on/off, the sustain discharge circuit part 70 and the first panel block 72 are completely connected or disconnected. The second switching unit (712, 713) has the same structure as the first switching unit.

Although not illustrated, if the FETs provided in the switching parts 61 and 71 of FIGS. 6 and 7 are serially connected in an opposite direction, they can perform the completely connecting or disconnecting function. Therefore, their directions can be changed.

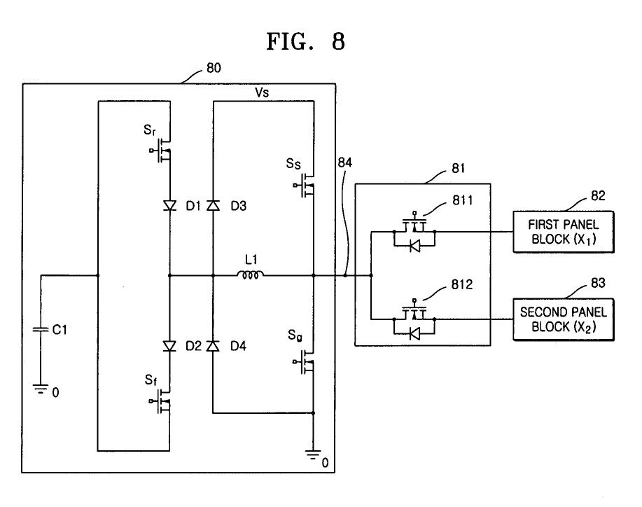

FIG. 8 is a detailed view of the panel driving apparatus shown in FIG. 5 according to another embodiment of the present invention. In FIG. 8, the panel driving apparatus includes two panel blocks 82 and 83. A difference from FIGS. 6 and 7 is that one panel block is switched by only one FET switch.

In one embodiment, one sustain discharge circuit part 80 is connected to first and second panel blocks 82 and 83 by a switching part 81. A structure and operation of the sustain discharge circuit part 80 shown in FIG. 8 is substantially the same as those of the sustain discharge circuit part 60 shown in FIG. 6.

The switching part 81 includes a FET switch 811 for switching the sustain discharge circuit part 80 and the first panel block 82, and a FET switch 812 for switching the sustain discharge circuit part 80 and the second panel block 83. Referring to FIG. 8, the first and second FETs 811 and 812 have drains connected to an output terminal 84 of the sustain discharge circuit part 80, and sources connected to the first and second panel blocks 82 and 83, respectively. When the first FET switch 811 is turned on and the second FET switch 812 is turned off, the second panel block 83 maintains a voltage lower than a low voltage V_{L} of the sustain discharge while the sustain pulse is applied to the first panel block 82, considering that the directions of the diodes are directed from the source to the drain. On the other hand, when the first FET switch 811 is turned ff and the second FET switch 812 is turned on, the first panel block 82 maintains a voltage lower than a low voltage V_{L} of the sustain discharge while the sustain pulse is applied to the second panel block 83, considering that the directions of the diodes are directed from the source to the drain.

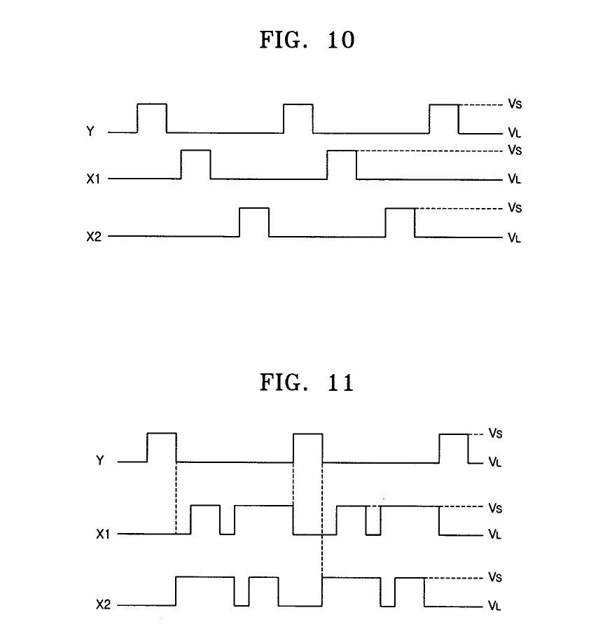

FIG. 10 is a diagram of a driving waveform of the panel driving apparatus shown in FIG. 8.

Referring to FIG. 10, when the sustain pulse of a high level V_{S} is applied to the first panel block X₁, the sustain pulse of a low level V_{L} is applied to the second panel block X₂. The low level V_{L} may be a ground voltage. Although not shown, a voltage lower than the low level V_{L} may be applied to the second panel block X₂.

On the other hand, when the sustain pulse of a high level V_{S} is applied to the second panel block X₂, the sustain pulse of a low level V_{L} is applied to the first panel block X₁. Although not shown, a voltage lower than the low level V_{L} may be applied to the first panel block X1.

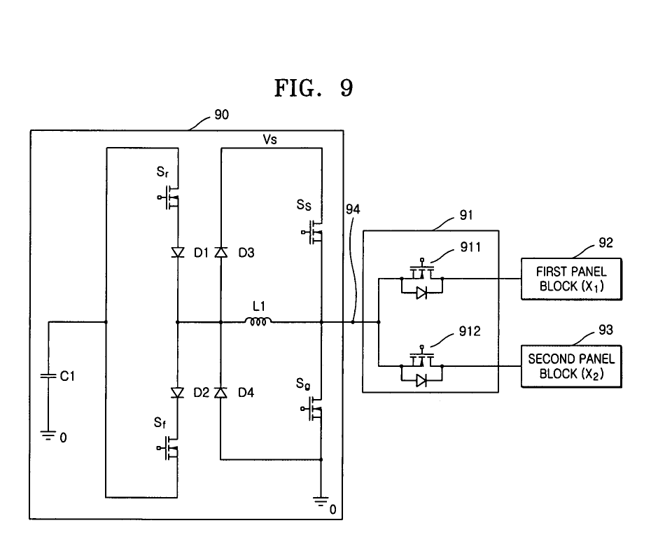

FIG. 9 is a view illustrating a modification of the panel driving apparatus shown in FIG. 8. A difference is that FETs of a switching part 91 have an opposite direction as compared to the FETs shown in FIG. 8.

Referring to FIG. 9, when a first switch 911 is turned on and the second switch 912 is turned off, the second panel block 93 maintainsmaintains a voltage higher than a high voltage V_{S} of the sustain discharge while the sustain pulse is applied to the first panel block 92, considering that the directions of the diodes are directed from the source to the drain. On the other hand, when the first switch 911 is turned off and the second switch 912 is turned on, the first panel block 92 maintains a voltage higher than a high voltage V_{S} of the sustain discharge while the sustain pulse is applied to the second panel block 93, considering that the directions of the diodes are directed from the source to the drain.

FIG. 11 is a diagram of a driving waveform of the panel driving apparatus shown in FIG. 9. As shown, when the sustain pulse of a high level V_{S} is applied to the first panel block X₁, the sustain pulse of a high level V_{S} is applied to the second panel block X₂. Although not shown, a voltage higher than the high level V_{S} may be applied to the second panel block X₂.

On the other hand, when the sustain pulse of a high level V_{S} is applied to the second panel block X₂, the sustain pulse of a high level V_{S} is applied to the first panel block X₁. Although not shown, a voltage higher than the high level V_{S} may be applied to the first panel block X₁.

The panel driving apparatus according to the present invention can be applied to almost any type of display, which performs the address period of selecting in advance the cells to be turned on and the sustain period of light-emitting the selected cells in sequence. It will be apparent to those skilled in the art that the present invention may be applied to an apparatus for displaying an image by alternately applying the sustain pulses to the electrodes, which form an AC type PDP, a DC type PDP, an electroluminescent display (ELD), a liquid crystal display (LCD), etc.

According to the panel driving apparatus of the present invention, when the electrodes of the panel are separated in blocks, the panel driving apparatus can be implemented at a low cost without any circuit variation during the sustain discharge.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A panel driving apparatus for driving a panel having a plurality of panel blocks for a sustain discharge, the panel driving apparatus comprising:
a sustain discharge circuit part having an output terminal and supplying a sustain pulse through the output terminal to the panel; and
a switching part having a plurality of control switches for connecting the output terminal of the sustain discharge circuit part to the plurality of panel blocks.

2. The panel driving apparatus of claim 1, wherein each of the control switches includes two FET switches serially connected in an opposite direction.

3. The panel driving apparatus of claim 1, wherein when one control switch is turned on, the remaining control switches are turned off, such that one panel block is turned on and the remaining panel blocks are in an idle period while the sustain pulse is applied to the one panel block.

4. The panel driving apparatus of claim 1, wherein each of the control switches includes one FET switch.

5. The panel driving apparatus of claim 4, wherein each FET has a drain connected to the output terminal of the sustain discharge circuit part, and a source connected to a corresponding panel block.

6. The panel driving apparatus of claim 5, wherein when one control switch is turned on, the remaining control switches are turned off, such that one panel block is turned on and a voltage equal to or lower than a low level of the sustain pulse is applied to the remaining panel blocks.

7. The panel driving apparatus of claim 6, wherein the remaining panel blocks are turned off when the sustain pulse is applied.

8. The panel driving apparatus of claim 4, wherein each FET has a source connected to the output terminal of the sustain discharge circuit part, and a drain connected to a corresponding panel block.

9. The panel driving apparatus of claim 8, wherein when one control switch is turned on, the remaining control switches are turned off, such that one panel block is turned on and a voltage equal to or higher than a high level of the sustain pulse is applied to the remaining panel blocks.

10. The panel driving apparatus of claim 9, wherein the remaining panel blocks are turned off.

11. A driving apparatus for driving a plasma display panel, the driving apparatus comprising:
a plurality of panel blocks;
a sustain discharge circuit part connected to the plurality of panel blocks by a switching part, wherein the switching part further comprises:
a first switching unit for switching the sustain discharge circuit part and a first panel block of the plurality of panel blocks; and
a second switching unit for switching the sustain discharge circuit part and a second panel block of the plurality of panel blocks,
wherein the first switching unit and the second switching unit each include two field effect transistors (FETs) connected in an opposite direction.

12. The driving apparatus of claim 11, wherein a first FET of the two FETs has a source connected to an output terminal of the sustain discharge circuit part, and wherein a second FET of the two FETs has a source connected to one of the first panel block or the second panel block.

13. The driving apparatus of claim 11, wherein a first FET of the two FETs has a drain connected to an output terminal of the sustain discharge circuit part, and wherein a second FET of the two FETs has a drain connected to one of the first panel block or the second panel block.

14. A driving apparatus for driving a plasma display panel, the driving apparatus comprising: a plurality of panel blocks;
a sustain discharge circuit part connected to the plurality of panel blocks by a switching part, wherein the switching part further comprises:
a first switching unit for switching the sustain discharge circuit part and a first panel block of the plurality of panel blocks; and
a second switching unit for switching the sustain discharge circuit part and a second panel block of the plurality of panel blocks,
wherein the first switching unit and the second switching unit each include a single field effect transistors (FETs) having a drain connected to an output of the sustain driving circuit part and a source connected to one of a first panel block or a second panel block of the plurality of panel blocks.

15. The driving apparatus of claim 13, wherein when the FET of the first switching unit is turned on and the FET of the second switching unit is turned off, the second panel block maintains a voltage lower than a sustain discharge voltage while a sustain pulse is applied to the first panel block.

16. The driving apparatus of claim 13, wherein when the FET of the first switching unit is turned off and the FET of the second switching unit is turned on, the first panel block maintains a voltage lower than a sustain discharge voltage while a sustain pulse is applied to the second panel block.

17. A driving apparatus for driving a plasma display panel, the driving apparatus comprising: a plurality of panel blocks;
a sustain discharge circuit part connected to the plurality of panel blocks by a switching part, wherein the switching part further comprises:
a first switching unit for switching the sustain discharge circuit part and a first panel block of the plurality of panel blocks; and
a second switching unit for switching the sustain discharge circuit part and a second panel block of the plurality of panel blocks,
wherein the first switching unit and the second switching unit each include a single field effect transistors (FETs) having a source connected to an output of the sustain driving circuit part and a drain connected to one of a first panel block or a second panel block of the plurality of panel blocks.

18. The driving apparatus of claim 17, wherein when the FET of the first switching unit is turned on and the FET of the second switching unit is turned off, the second panel block maintains a voltage higher than a sustain discharge voltage while a sustain pulse is applied to the first panel block.

19. The driving apparatus of claim 17, wherein when the FET of the first switching unit is turned off and the FET of the second switching unit is turned on, the first panel block maintains a voltage higher than a sustain discharge voltage while a sustain pulse is applied to the second panel block.
